(19) United States
(12) Patent Application Publication
(10) Pub. No.: US 2026/0358669 A1
(43) Pub. Date: Nov. 12, 2026

(54) OPTICAL MODULATOR, LIGHT SOURCE MODULE, AND IMAGE DISPLAY DEVICE

(71) Applicant: TDK CORPORATION, Tokyo (JP)

(72) Inventors: Kazuki NAKADA, Tokyo (JP); Yusuke SHIGETA, Tokyo (JP); Shigeru MIEDA, Tokyo (JP)

(73) Assignee: TDK CORPORATION, Tokyo (JP)

(21) Appl. No.: 19/665,323

(22) Filed: May 1, 2026

(30) Foreign Application Priority Data
May 9, 2025 (JP) 2025-078702
Jan. 29, 2026 (JP) 2026-013114

(51) Int. Cl. G02F 1/21; G02F 1/225

(52) U.S. Cl. CPC G02F 1/212; G02F 1/225; G02F 2202/20

(57) ABSTRACT

Provided is an optical modulator to enable optical output that efficiently and appropriately reflects gamma correction in optical modulation using a Mach-Zehnder optical waveguide. An optical modulator 101 that modulates visible light is provided with a Mach-Zehnder optical waveguide 20, an optical modulation element 11 having electrodes 31, 32 that apply an electric field to the Mach-Zehnder optical waveguide 20, and a voltage application portion 111 that specifies a voltage value based on modulation characteristics that reflect gamma correction as a voltage value corresponding to an input pixel signal, and applies the specified voltage value to the electrodes 31, 32.

### CROSS-REFERENCE TO RELATED APPLICATION

This application claims a priority, under the Paris Convention, to Japanese Patent Application No. 2025-78702 filed on May 9, 2025, and Japanese Patent Application No. 2026-13114 filed on Jan. 29, 2026, the entirety of which is incorporated herein by reference.

### TECHNICAL FIELD

The present disclosure relates to an optical modulator, a light source module, and an image display device.

### BACKGROUND ART

Conventionally, optical modulators that modulate visible light emitted by light sources such as laser diodes are known, for example, optical modulators in which an optical waveguide is formed from a material with an electro-optic effect, such as lithium niobate (LiNbO₃). In particular, optical modulators that use a Mach-Zehnder optical waveguide with a Mach-Zehnder interferometer structure have attracted attention because they have excellent high-speed response, low power consumption, and can be made compact. Such optical modulators are being installed in light source modules included in XR glasses and small projectors. XR is a general term for virtual reality (VR), augmented reality (AR), and mixed reality.

Japanese Patent Application Publication No. 2021-48470 discloses a projection device that includes light modulation elements corresponding to each color of visible light, and that performs image processing on a video signal in an image processing portion, and then controls the voltage applied to each light modulation element based on the video signal after the image processing to modulate the visible light of each color. The image processing portion applies image processing to the video signal, including geometric transformation processing, scalar processing, aspect conversion processing, frame thinning processing, frame interpolation processing, and resolution conversion processing, as well as gamma correction, color adjustment, and contrast adjustment to correct image quality. In the technology disclosed in Japanese Patent Application Publication No. 2021-48470, gamma correction is performed on the video signal by image processing, and the voltage applied to the light modulation element is controlled based on the video signal after gamma correction.

However, in the technology disclosed in Japanese Patent Application Publication No. 2021-48470, after gamma correction is performed by image processing, the voltage value of the optical modulation is determined based on the image signal after gamma correction, which is not necessarily an efficient process. In particular, the optical modulation using a Mach-Zehnder optical waveguide has nonlinear modulation characteristics. For this reason, as recognized by the present inventors, it is extremely inefficient to convert the luminance (brightness) of an image, which has linearity, to have nonlinearity in accordance with the visual characteristics of humans, and further, to perform nonlinear conversion to a voltage value in optical modulation using a Mach-Zehnder optical waveguide.

One aspect of the present disclosure provides an optical modulator for modulating visible light, comprising: an optical modulation element having a Mach-Zehnder optical waveguide formed therein and an electrode configured to apply an electric field to the Mach-Zehnder optical waveguide, and a voltage application portion for specifying a voltage value based on modulation characteristics reflecting gamma correction as a voltage value corresponding to an input pixel signal, and applying the specified voltage value to the electrode.

One aspect of the present disclosure provides a light source module comprising the optical modulator and a plurality of light sources that each emit visible light of different wavelengths.

One aspect of the present disclosure provides an image display device wherein an image is displayed using visible light output from the light source module.

### BRIEF DESCRIPTION OF DRAWINGS

FIG. 1 is a schematic plan view of a light source module in a first embodiment of the present disclosure.

FIG. 2 is a diagram for explaining a Mach-Zehnder optical waveguide formed in the optical modulation element of the light source module shown in FIG. 1.

FIG. 3A is a cross-sectional view taken along line A-A in FIG. 2.

FIG. 3B is a cross-sectional view of an optical modulation element according to a first modification of the first embodiment of the present disclosure.

FIG. 3C is a cross-sectional view of an optical modulation element according to a second modification of the first embodiment of the present disclosure.

FIG. 3D is a diagram schematically illustrating a method for manufacturing the optical modulation element shown in FIG. 3B.

FIG. 4 is a conceptual diagram showing a drawing area on an image display surface, and showing an example of a scanning method.

FIG. 5 is a conceptual diagram showing a pattern of pixel voltages applied to one of multiple Mach-Zehnder optical waveguides on the vertical axis, with time on the horizontal axis.

FIG. 6 is a diagram conceptually illustrating the arrangement of three consecutive pixels that make up an image.

FIG. 7 is a diagram conceptually illustrating the combination of RGB pixel voltages for each of 1280 pixels in one row when the number of pixels in one image is “1280×720”.

FIG. 8 is a block diagram for explaining the control function of the optical modulator in the first embodiment of the present disclosure.

FIG. 9 is a graph showing an example of a tone curve in gamma correction.

FIG. 10 is a graph showing an example of a general modulation curve for a Mach-Zehnder optical waveguide.

FIG. 11 is a graph showing a modulation curve reflecting gamma correction in the first embodiment of the present disclosure.

FIG. 12 is a block diagram for explaining the control function of the optical modulator in the second embodiment of the present disclosure.

FIG. 13 is a block diagram for explaining the control function of the optical modulator in the third embodiment of the present disclosure.

FIG. 14 is a block diagram for explaining the control function of the optical modulator in the fourth embodiment of the present disclosure.

FIG. 15 is a conceptual diagram for explaining XR glasses, which are an example of an image display device according to the present disclosure.

FIG. 16 is a conceptual diagram showing how an image is projected directly onto the retina by laser light emitted from a light source module in the XR glasses shown in FIG. 15.

### DETAILED DESCRIPTION

Hereinafter, an embodiment of the present disclosure will be described in detail with reference to the drawings as appropriate. The drawings used in the following description may show characteristic parts in an enlarged scale for the sake of convenience in order to make the characteristics easier to understand, and the dimensions and ratios of each component may differ from the actual ones. The materials, dimensions, etc. exemplified in the following description are merely examples. The present disclosure is not limited to these examples, and may be modified as appropriate within the scope of the effects of the present disclosure. In addition, the numerical range “X to Y” described in this specification means any numerical value within the range including the lower limit value X and the upper limit value Y.

One aspect of the present disclosure can provide an optical modulator, a light source module, and an image display device that can output light that efficiently and appropriately reflects gamma correction in optical modulation using a Mach-Zehnder optical waveguide.

### First Embodiment

The first embodiment of the present disclosure will be described below.

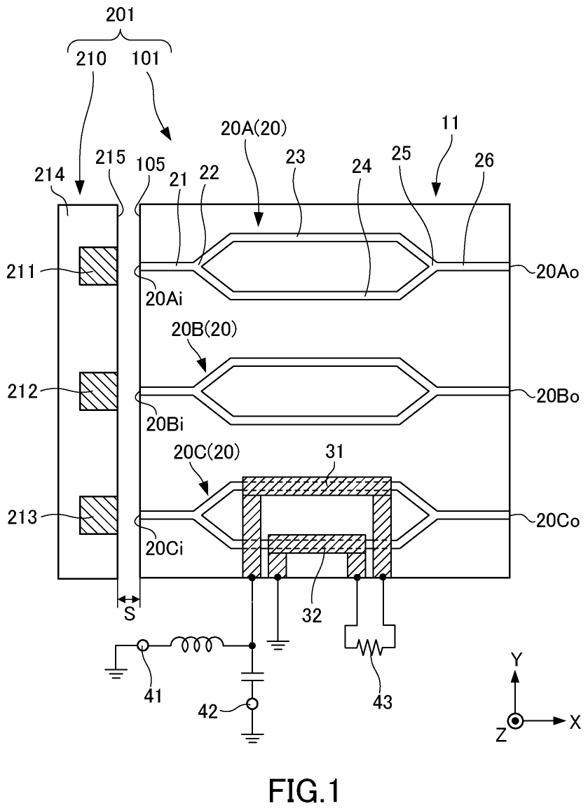

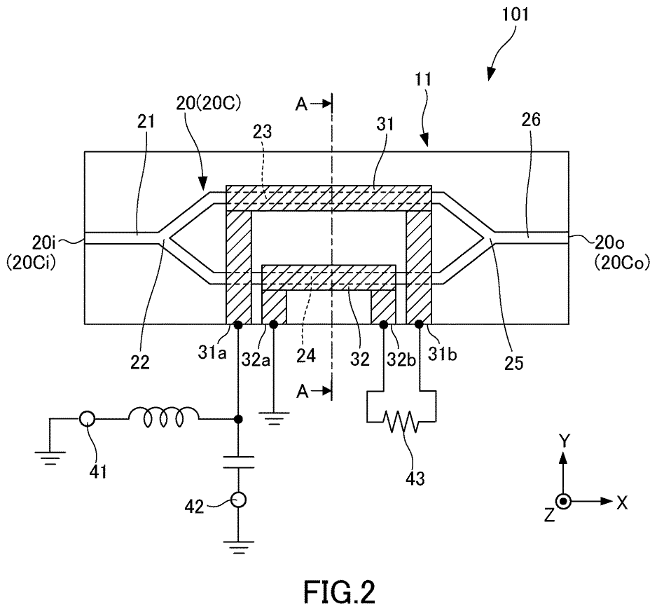

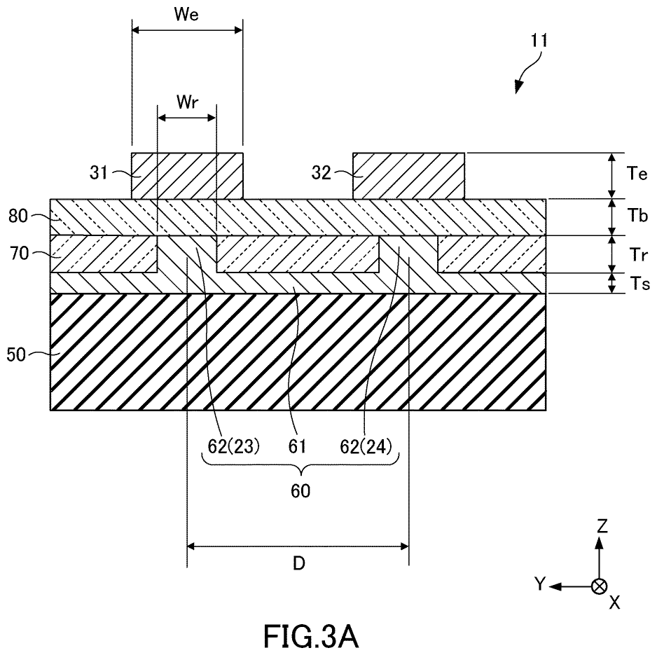

First, the configuration of the light source module 201 in the first embodiment of the present disclosure will be described with reference to FIGS. 1 to 3A. FIG. 1 is a schematic plan view of the light source module 201 in the first embodiment. FIG. 2 is a diagram for explaining the Mach-Zehnder optical waveguide 20 formed in an optical modulation element 11 of the light source module 201 shown in FIG. 1. FIG. 3A is a cross-sectional view taken along line A-A in FIG. 2.

In this specification, in the XYZ orthogonal coordinate system set in the figure, the direction along one side of the optical modulation element 11 is the X direction, the direction perpendicular to the X direction is the Y direction, and the direction perpendicular to the X and Y directions is the Z direction. The X direction coincides with the direction of light incidence from the multiple light sources 211, 212, and 213 to the optical modulation element 11. The X direction corresponds to the longitudinal direction of the optical modulation element 11. The Y direction corresponds to the width direction of the optical modulation element 11. The Z direction is perpendicular to the main surface of the optical modulation element 11. In addition, the direction is expressed as “positive Z direction” or “negative Z direction” in consideration of the direction, and the “positive Z direction” is sometimes referred to as the upward direction and the “negative Z direction” as the downward direction. Here, the Z direction, which is the up-down direction, does not necessarily coincide with the direction in which gravity acts.

The light source module 201 shown in FIG. 1 is configured with a light source portion 210 and an optical modulator 101.

The light source portion 210 has a plurality of light sources 211, 212, and 213 arranged on a subcarrier 214. The plurality of light sources 211, 212, and 213 are light sources that emit visible light of a certain intensity. The light source module 201 functions as a visible light source module.

The light sources 211, 212, 213 may be, for example, laser diodes (LD) or laser light-emitting diodes (LED) that emit red light (R), green light (G), blue light (B), etc. In this embodiment, the light sources 211, 212, 213 are provided with laser diodes that emit visible light of three colors: red light, green light, and blue light. Specifically, the light source 211 is a laser diode that emits red light, the light source 212 is a laser diode that emits green light, and the light source 213 is a laser diode that emits blue light. However, the arrangement order of the light sources 211, 212, 213 that emit each color is not particularly limited.

For example, the visible light with a peak wavelength of 590 to 800 nm is used for the red light. For example, the visible light with a peak wavelength of 490 to 590 nm is used for the green light. For example, the visible light with a peak wavelength of 380 to 490 nm is used for the blue light. By superimposing these emitted lights based on the principle of additive color mixing, a desired color can be expressed. Here, three light sources 211, 212, and 213 that emit light of the three primary colors (red, green, and blue) are arranged, but four or more light sources may be arranged. Also, light sources that emit light of colors other than the three primary colors may be used.

The light sources 211, 212, and 213 are arranged at intervals from each other in a direction approximately perpendicular to the emission direction of the light emitted by each of them.

The light sources 211, 212, and 213 are fixed to the optical modulation element 11 that constitutes the optical modulator 101. The light sources 211, 212, and 213 are mounted on the upper surface of the subcarrier 214, for example, in the form of bare chips. The subcarrier 214 and the substrate 50 of the optical modulation element 11 are bonded through a metal bonding layer or the like. When the light source module 201 is manufactured, the relative positions of the subcarrier 214 and the substrate 50 are adjusted so that the optical axes of the light sources 211, 212, and 213 coincide with the axes of the input ports 20Ai, 20Bi, and 20Ci of the Mach-Zehnder optical waveguides 20A, 20B, and 20C. The optical axis adjustment is performed, for example, by active alignment.

In the light source module 201, the light exit surfaces 215 of the light sources 211, 212, and 213 and the light entrance surface 105 of the optical modulator 101 are arranged to face each other. The light exit surface 215 and the light entrance surface 105 are separated by a predetermined distance (spacing S in FIG. 1) to form a gap, which is filled with air. By setting the spacing S to be greater than 0 μm and equal to or less than 5 μm, light can be made to enter the input ports 20Ai, 20Bi, and 20Ci of the Mach-Zehnder optical waveguides 20A, 20B, and 20C while satisfying a predetermined coupling efficiency.

The optical modulator 101 has an optical modulation element 11 in which multiple Mach-Zehnder optical waveguides 20 (Mach-Zehnder optical waveguides 20A, 20B, and 20C) are formed. In FIG. 1, three Mach-Zehnder optical waveguides 20A, 20B, and 20C are formed in the optical modulation element 11, but four or more Mach-Zehnder optical waveguides may be formed depending on the number of light sources used.

The three Mach-Zehnder optical waveguides 20A, 20B, and 20C are provided corresponding to the three colors of visible light emitted by the three light sources 211, 212, and 213. The light input to the input ports 20Ai, 20Bi, and 20Ci of the Mach-Zehnder optical waveguides 20A, 20B, and 20C is modulated independently by each of the Mach-Zehnder optical waveguides 20A, 20B, and 20C.

The visible light of each wavelength is modulated by each Mach-Zehnder optical waveguide 20A, 20B, 20C to a specific intensity ratio, and output from three output ports 20Ao, 20Bo, 20Co. The desired color can be expressed by overlapping these output lights. The output lights from each output port 20Ao, 20Bo, 20Co may be supplied to an optical multiplexer and combined into light that expresses a mixed color (intermediate color). Alternatively, the output lights of each wavelength may be appropriately overlapped without using an optical multiplexer so that they can be visually recognized as one mixed color.

The three Mach-Zehnder optical waveguides 20A, 20B, 20C are provided on the same substrate 50 (see FIG. 3A) and extend parallel to each other as a whole. In this way, by providing a plurality of Mach-Zehnder optical waveguides 20A, 20B, and 20C on the same substrate 50, it is possible to achieve miniaturization. Each of the Mach-Zehnder optical waveguides 20A, 20B, and 20C may be provided on a different substrate.

Electrodes 31 and 32 are provided on each of the Mach-Zehnder optical waveguides 20A, 20B, and 20C. For the sake of simplicity, in FIG. 1, electrodes 31 and 32 are only shown on the Mach-Zehnder optical waveguide 20C, but the other Mach-Zehnder optical waveguides 20A and 20B also have electrodes 31 and 32 provided in the same manner.

The optical modulation element 11 constituting the optical modulator 101 includes a Mach-Zehnder optical waveguide 20 formed above the substrate 50, and electrodes 31 and 32. FIG. 2 and FIG. 3A show a schematic view of the vicinity of the Mach-Zehnder optical waveguide 20C formed in the optical modulation element 11, but the other Mach-Zehnder optical waveguides 20A and 20B have the same configuration. The input port 20i shown in FIG. 2 corresponds to the input ports 20Ai, 20Bi, and 20Ci of the Mach-Zehnder optical waveguides 20A, 20B, and 20C. The output port 200 shown in FIG. 2 corresponds to the output ports 20Ao, 20Bo, and 20Co of the Mach-Zehnder optical waveguides 20A, 20B, and 20C.

The Mach-Zehnder optical waveguide 20 is a Mach-Zehnder type optical waveguide having a Mach-Zehnder interferometer structure. One input optical waveguide 21 is branched into a first optical waveguide 23 and a second optical waveguide 24 by a splitter 22. The first optical waveguide 23 and the second optical waveguide 24 extend parallel to each other and are coupled to one output optical waveguide 26 by a multiplexer 25. The output optical waveguide 26 extends from the multiplexer 25 and is connected to the output port 200.

Light inputted from the input port 20i to the input optical waveguide 21 is split by the splitter 22 and modulated while traveling (propagating) through the first optical waveguide 23 and the second optical waveguide 24. The light is then multiplexed by the multiplexer 25, travels through the output optical waveguide 26, and is outputted from the output port 200.

The electrodes 31 and 32 are electrodes for applying an electric field to the Mach-Zehnder optical waveguide 20. The electrode 31 is arranged along the first optical waveguide 23, and the electrode 32 is arranged along the second optical waveguide 24. The light traveling through the first optical waveguide 23 and the second optical waveguide 24 is modulated by the action of the electric field generated by the potential difference between the electrodes 31 and 32. It is sufficient to generate a potential difference between the electrodes 31 and 32, and a voltage may be applied to only one of the electrodes 31 and 32, and the other may be set to a reference potential (for example, a ground potential). The electrode structure is not particularly limited, and it is sufficient that it generates an electric field appropriately in the Mach-Zehnder optical waveguide 20.

The electrodes 31 and 32 are arranged directly above the ridge portion 62 that forms the first optical waveguide 23 and the second optical waveguide 24. In FIG. 2, the length of the portion where the electrode 31 and the first optical waveguide 23 overlap in the vertical direction is different from the length of the portion where the electrode 32 and the second optical waveguide 24 overlap in the vertical direction, but in reality, these lengths are set to be approximately the same.

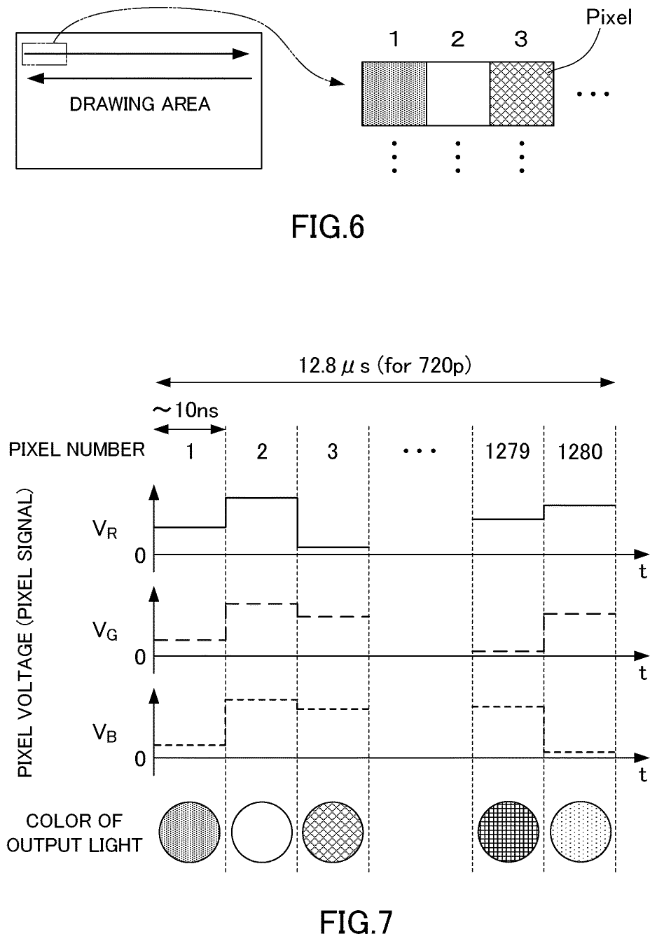

One end 31a of the electrode 31 is connected to the first power source 41 and the second power source 42, and the other end 31b is connected to the termination resistor 43. One end 32a of the electrode 32 is grounded, and the other end 32b is connected to the termination resistor 43. The first power source 41 constitutes a part of the drive circuit 112 (see FIG. 8) for applying the modulation voltage. The second power source 42 constitutes a part of the offset voltage application circuit 113 (see FIG. 8) for applying the offset voltage. The offset voltage includes, for example, a bias voltage for adjusting the bias point.

In the configuration shown in FIG. 2, the modulation voltage and offset voltage are applied to the electrodes 31, 32 in a superimposed state. However, an electrode for the modulation voltage and an electrode for the offset voltage may be provided separately, and the modulation voltage and the offset voltage may be applied in different regions.

As shown in FIG. 3A, the optical modulation element 11 has a multilayer structure in which a ferroelectric thin film 60, a protective layer 70, and a buffer layer 80 are stacked in this order on a substrate 50. Electrodes 31, 32 are placed on the buffer layer 80.

The ferroelectric thin film 60 is a ferroelectric thin film, and may be an ABX₃-type ferroelectric thin film including a crystal represented by the chemical equation ABX₃. A material having an electro-optic effect can be used as the material of the ferroelectric thin film 60. Examples of the material of ABX₃-type ferroelectric thin film having an electro-optic effect include oxide ferroelectrics such as lithium niobate (LiNbO₃), lithium tantalate (LiTaO₃), and barium titanate (BaTiO₃). The optical modulation element 11 using lithium niobate for the ferroelectric thin film 60 is sometimes called an LN optical modulation element, and the optical modulator 101 in which the LN optical modulation element is implemented is sometimes called an LN optical modulator.

As shown in FIG. 3A, the ferroelectric thin film 60 is composed of a slab layer 61 having a predetermined thickness and a ridge portion 62 protruding from the upper surface of the slab layer 61. The ridge portion 62 can confine light therein and form an optical waveguide that propagates the light.

The ridge portion 62 is provided at a position where the Mach-Zehnder optical waveguide 20 is formed. As shown in FIG. 3A, the first optical waveguide 23 and the second optical waveguide 24 are formed at the position where the ridge portion 62 is provided. The ridge portion 62 may be a protruding portion formed by etching the ferroelectric thin film 60, or may be formed by attaching the same material as the ferroelectric thin film 60 to the upper surface of the ferroelectric thin film 60. The shape of the ridge portion 62 is not particularly limited, and the cross section may be rectangular or dome-shaped. Note that FIG. 3A exemplifies a cross section taken along line A-A in FIG. 2, but a similar ridge-type optical waveguide can also be formed in optical waveguides at other locations.

The thickness of the slab layer 61 (thickness Ts in FIG. 3A) may be, for example, 0.1 to 0.3 μm. If the optical waveguide formed by the ridge portion 62 is extremely small, light does not propagate properly, and if the ridge portion 62 is extremely large, the propagating light becomes multi-mode. For this reason, the ridge portion 62 may be set to an appropriate size. The thickness of the ridge portion 62 (thickness Tr in FIG. 3A) may be, for example, 0.5 to 1.0 μm, and the width of the top surface of the ridge portion 62 (width Wr in FIG. 3A) may be 0.3 to 1.2 μm.

By reducing the distance between adjacent ridge portions 62, the electric field efficiency provided to the optical waveguide formed by the ridge portions 62 can be improved. The distance between the centers of adjacent ridge portions 62 (distance D in FIG. 3A) may be, for example, 2 to 12 μm.

Instead of forming an optical waveguide by the ridge portions 62, an optical waveguide may be formed by providing a region with a high refractive index in the ferroelectric thin film 60. For example, a region with a high refractive index may be created locally in the ferroelectric thin film 60 by Ti diffusion or proton exchange, and this region may be used as the optical waveguide.

The substrate 50 is not particularly limited as long as it has a lower refractive index than the ferroelectric thin film 60, but the substrate 50 may be a substrate on which the ferroelectric thin film 60 can be formed as an epitaxial film with excellent crystallinity. As the substrate 50, for example, a substrate made of a material containing aluminum oxide (sapphire substrate), a silicon single crystal substrate, a thermally oxidized silicon substrate, or the like can be used, and in particular, a sapphire single-crystal substrate can be used.

The crystal orientation of the substrate 50 is not particularly limited, but since it serves as the base for the ferroelectric thin film 60, it may have the same symmetry as the ferroelectric thin film 60. Specifically, a lithium niobate film has three-fold symmetry, and when a lithium niobate film with a c-axis orientation is used as the ferroelectric thin film 60, it is possible to use a substrate 50 with a c-plane if it is a sapphire single crystal substrate, or a (111) plane if it is a silicon single crystal substrate.

An epitaxial film is a film in which crystals grow based on the crystal orientation of the underlying substrate 50 and are oriented in a specific crystal orientation in accordance with the crystal structure of the substrate 50. Whether the ferroelectric thin film 60 is an epitaxial film on the substrate 50 can be proven, for example, by performing peak intensity and pole analysis at the orientation position in 2θ-θ X-ray diffraction.

Specifically, when measuring by 2θ-θ X-ray diffraction, all peak intensities other than the target plane must be 10% or less, and more specifically 5% or less, of the maximum peak intensity of the target plane. For example, in the case of an epitaxial film made of a lithium niobate film with a c-axis orientation, the peak intensity other than the (00L) plane must be 10% or less, and more specifically 5% or less, of the maximum peak intensity of the (00L) plane. Here, (00L) is a general designation for equivalent planes such as (001) and (002), etc.

It is also necessary to observe the poles in the pole analysis. Confirming the peak intensity at a specific orientation position only evaluates the crystal orientation in one direction. Therefore, even if it is confirmed that the peak intensity is below a certain value, if the crystal orientation is not aligned within the plane, the X-ray intensity will not increase at a specific angle position and no poles will be observed. Since LiNbO₃ has a trigonal crystal structure, there are three poles of LiNbO₃(014) in a single crystal.

It is known that in the case of lithium niobate films, epitaxial growth occurs in a so-called twin state, in which crystals rotated 180° around the c-axis are symmetrically bonded. In this case, six poles are observed because two of the three poles are symmetrically bonded. In addition, when a lithium niobate film is formed on a silicon single crystal substrate with a (100) plane, 4×3=12 poles are observed because the substrate has four-fold symmetry. In this disclosure, the epitaxial film also includes lithium niobate films that have grown epitaxially in a twin crystal state.

The composition of lithium niobate is LiₓNbA_{y}O_{z}. x is 0.5 to 1.2, and more specifically 0.9 to 1.05. y is 0 to 0.5. z is 1.5 to 4.0, and more specifically 2.5 to 3.5. The element A is an element other than Li, Nb, and O. Examples of elements for A include K, Na, Rb, Cs, Be, Mg, Ca, Sr, Ba, Ti, Zr, Hf, V, Cr, Mo, W, Fe, Co, Ni, Zn, Sc, Ce, etc., and may be a combination of two or more of these elements.

The ferroelectric thin film 60 is not limited to one formed by epitaxial growth, and may be a thin film bonded to the upper surface of the substrate 50.

As shown in FIG. 3A, the protective layer 70 is disposed between the slab layer 61 of the ferroelectric thin film 60 and the buffer layer 80. In FIG. 3A, the protective layer 70 is filled between adjacent ridge portions 62, and is disposed so as to cover the upper surface of the slab layer 61 and the side surface of the ridge portion 62.

The protective layer 70 is made of a dielectric material having a smaller refractive index than the ferroelectric thin film 60. The material of the protective layer 70 may be, for example, silicon oxide (SiO₂), aluminum oxide (Al₂O₃), lanthanum oxide (La₂O₃), or a composite of these oxides. The composite of the oxides may be, for example, LaAlSiInO. Of the above, it is possible to use silicon oxide as the material of the protective layer 70.

The buffer layer 80 is formed on the ferroelectric thin film 60 and the protective layer 70. In the configuration shown in FIG. 3A, the protective layer 70 is filled between the adjacent ridge portions 62, and the buffer layer 80 is disposed so as to cover the upper surface of the protective layer 70 and the upper surface of the ridge portion 62. The buffer layer 80 has a role of preventing visible light propagating through the ferroelectric thin film 60 from being absorbed by the electrodes 31 and 32.

The buffer layer 80 is made of a dielectric material having a smaller refractive index than the ferroelectric thin film 60. The dielectric material constituting the buffer layer 80 may have a dielectric constant of 7 or more, which can reduce the electric field efficiency VπL (an index representing the electric field efficiency). Here, Vπ is the half-wave voltage, which is defined as the voltage required to shift the phase of the light by 180 degrees (the difference between the voltage value at which the optical output is maximum and the voltage value at which the optical output is minimum). VπL is the product of the half-wave voltage Vπ and the electrode length L, and the smaller VπL is, the more compact and the lower the drive voltage can be realized.

The material of the dielectric material constituting the buffer layer 80 can be aluminum oxide (dielectric constant 7), LaAlSiInO (dielectric constant 11), etc. The material of the buffer layer 80 may be the same as that of the protective layer 70, or may be a different material. When the protective layer 70 and the buffer layer 80 are made of the same material, the protective layer 70 and the buffer layer 80 can be formed as an integrated layer. The ridge portion 62 is covered with dielectric thin films constituting the protective layer 70 and the buffer layer 80.

The thickness of the buffer layer 80 (thickness Tb in FIG. 3A) may be 0.4 to 1.0 μm, which allows the electric field efficiency VπL to be reduced.

Electrodes 31 and 32 are disposed on the upper surface of the buffer layer 80. The material of the electrodes 31 and 32 is a metal material with high electrical conductivity, and it is possible to use, for example, Au, Cu, Ag, Pt, etc. The width of the electrodes 31 and 32 (width We in FIG. 3A) may be 1.0 to 4.0 μm, which allows the electric field efficiency VπL to be reduced. The thickness of the electrodes 31 and 32 (thickness Te in FIG. 3A) may be 0.1 to 5.0 μm, which allows the high-frequency modulation voltage to be transmitted efficiently.

Here, the ferroelectric thin film 60 is a c-axis-oriented (or Z-cut) lithium niobate film. In the c-axis-oriented (or Z-cut) lithium niobate film, the electro-optic effect is strongly exhibited in the Z direction in the drawings of this application. For this reason, as shown in FIG. 3A, the electrodes 31 and 32 may be disposed directly above the ridge portion 62 that forms the first optical waveguide 23 and the second optical waveguide 24. An electric field generated between the electrodes 31 and 32 is applied to the first optical waveguide 23 and the second optical waveguide 24. An asymmetric electric field, in which the top and bottom directions are reversed, is applied to the first optical waveguide 23 and the second optical waveguide 24. The refractive indexes of the first optical waveguide 23 and the second optical waveguide 24 change to +Δn and −Δn, respectively, due to the action of the electric field, and the phase difference of the light traveling through each optical waveguide changes. The light modulated by this change in phase difference is combined in the multiplexer 25 and output from the output port 200.

However, an a-axis-oriented (or X-cut) lithium niobate film may be used for the ferroelectric thin film 60. In this case, the electro-optic effect is strongly exhibited in the Y direction in the drawings of the present application, and the electrodes 31 and 32 may be disposed on the sides of the ridge portion 62 that forms the first optical waveguide 23 and the second optical waveguide 24.

In the optical modulation element 11 described above, as shown in FIG. 3A, a ridge-type optical waveguide is formed by the ridge portion 62 formed in a part of the ferroelectric thin film 60, but the configuration of the optical waveguide is not limited thereto.

Hereinafter, modified examples of the optical modulation element 11 described above will be described. FIG. 3B is a cross-sectional view of an optical modulation element 11A according to a first modified example, and FIG. 3C is a cross-sectional view of an optical modulation element 11B according to a second modified example. FIGS. 3B and 3C, similarly to FIG. 3A, show cross sections corresponding to line A-A in FIG. 2. The optical modulation element 11 shown in FIG. 3A can be replaced with the optical modulation element 11A shown in FIG. 3B or the optical modulation element 11B shown in FIG. 3C.

In the optical modulation elements 11A and 11B shown in FIGS. 3B and 3C, hybrid-type optical waveguides are formed as optical waveguides. A hybrid-type optical waveguide has a waveguide structure obtained by combining the ferroelectric thin film 60 and dielectric thin films 91 and 92 disposed above the ferroelectric thin film 60. The dielectric thin films 91 and 92 have a function of suppressing light propagating through the ferroelectric thin film 60 from spreading in the horizontal direction. The dielectric thin films 91 and 92 may be in direct contact with the ferroelectric thin film 60 as shown in FIG. 3B. Alternatively, as shown in FIG. 3C, an intermediate dielectric thin film 95 may be interposed between the ferroelectric thin film 60 and the dielectric thin films 91 and 92. Note that FIGS. 3B and 3C exemplify cross sections taken along line A-A in FIG. 2, but a similar hybrid-type optical waveguide can also be formed in optical waveguides at other locations.

The optical modulation element 11A according to a first modified example will be described with reference to FIG. 3B. Hereinafter, the same components as those of the optical modulation element 11 shown in FIG. 3A are denoted by the same names or reference numerals, and description thereof will be omitted as appropriate.

As shown in FIG. 3B, the optical modulation element 11A includes a substrate 50, a c-axis-oriented ferroelectric thin film (ABX₃-type ferroelectric thin film) 60, dielectric thin films (first dielectric thin films) 91 and 92, and a cladding (second dielectric thin film) 85. In this case, of the Mach-Zehnder optical waveguide 20, at least the first optical waveguide 23 and the second optical waveguide 24 include the ferroelectric thin film 60, the dielectric thin films 91 and 92, and the cladding 85.

The ferroelectric thin film 60 is, for example, a sputtered thin film formed on the substrate 50 by a sputtering method. The dielectric thin films 91 and 92 are directly formed on the ferroelectric thin film 60. In the optical modulation element 11A, the ferroelectric thin film 60 has a flat plate shape not including a ridge portion 62 protruding from the upper surface 60a thereof (see FIG. 3A). The cladding 85 is formed on the ferroelectric thin film 60 and the dielectric thin films 91 and 92. That is, in the dielectric thin film 91 on the ferroelectric thin film 60, the upper surface 91-1 and the side surfaces 91-2 and 91-3 are covered with the cladding 85, and in the dielectric thin film 92 on the ferroelectric thin film 60, the upper surface 92-1 and the side surfaces 92-2 and 92-3 are covered with the cladding 85.

The cross-sectional shapes of the dielectric thin films 91 and 92 are not particularly limited as long as they are shapes capable of guiding light. For example, they may be rectangular as shown in FIG. 3B, or may be square, trapezoidal, triangular, or the like. In any of these shapes, the lower surfaces 91-4 and 92-4 of the dielectric thin films 91 and 92 are in direct contact with the upper surface 60a of the ferroelectric thin film 60. The dielectric thin films 91 and 92 are formed of a material that transmits visible light without loss and is excellent in optical waveguide characteristics and processability. The dielectric thin films 91 and 92 are formed of, for example, any of elemental silicon, or oxides, nitrides, oxynitrides, or carbides of silicon, aluminum, zirconium, or tantalum. In the present embodiment, they are formed of silicon nitride (SiNₓ).

The cladding 85 functions as a cladding layer that confines light in the dielectric thin films 91 and 92 and the ferroelectric thin film 60. Therefore, the refractive index of the cladding 85 is lower than the refractive indexes of the ferroelectric thin film 60 and the dielectric thin films 91 and 92. For example, among materials constituting the cladding 85, silicon dioxide (SiO₂) or aluminum oxide (Al₂O₃) has a large refractive index difference from the ferroelectric thin film 60 serving as an electro-optic material, and is excellent in the effect of confining light in the ferroelectric thin film 60.

The dielectric thin films 91 and 92 and the ferroelectric thin film 60 are optically coupled and function as a three-dimensional optical waveguide, thereby forming a hybrid-type optical waveguide. Since the dielectric thin films 91 and 92 have a refractive index higher than that of the cladding 85, they suppress light in the ferroelectric thin film 60 from spreading greatly in the horizontal direction.

The method for forming the ferroelectric thin film 60 is not limited to a sputtering method, and a film-forming method such as a CVD (Chemical Vapor Deposition) method or a sol-gel method can also be used. The c-axis of the ferroelectric thin film 60 is oriented perpendicular to the main surface of the substrate 50, and by applying an electric field parallel to the c-axis, the optical refractive index can be efficiently changed in proportion to the electric field.

The lithium niobate film constituting the ferroelectric thin film 60 may be, for example, a lithium niobate single-crystal thin film bonded onto a substrate by a Smart Cut (registered trademark) technique. Specifically, a method for forming this lithium niobate single-crystal thin film includes an ion implantation step, a substrate bonding step, a layer separation step, and the like. In the ion implantation step, light ions such as hydrogen or helium are implanted into an LN donor wafer to form a damaged layer at a predetermined depth below the wafer surface determined by the implantation energy. In the substrate bonding step, the surface of the donor wafer into which ions have been implanted and the surface of a handling wafer (for example, a substrate composed of Si and SiO₂) are directly bonded. An insulating layer (for example, SiO₂) may be formed on the handling wafer as necessary. In the layer separation step, the bonded wafers are annealed, and the lithium niobate single-crystal thin film (transferred layer) is separated along the damaged layer. After the separation, the surface of the transferred layer may be planarized as necessary by chemical mechanical polishing, etching, or the like.

As a method for forming the ferroelectric thin film 60, a method of thinning or slicing a ferroelectric ABX₃ crystal substrate is also known. This method has an advantage that the same characteristics as those of a single crystal can be obtained, and can be applied to the present embodiment.

The optical modulation element 11A can be produced without using a bonding technique by laminating the ferroelectric thin film 60, the dielectric thin films 91 and 92, the cladding 85, and the electrodes 31 and 32 in this order on the substrate 50. The optical modulation element 11A thus produced has a low-defect film structure with precisely controlled film thicknesses.

The optical modulation element 11B according to a second modified example will be described with reference to FIG. 3C. Hereinafter, the same components as those of the optical modulation element 11 shown in FIG. 3A or the optical modulation element 11A shown in FIG. 3B are denoted by the same names or reference numerals, and description thereof will be omitted as appropriate.

As shown in FIG. 3C, the optical modulation element 11B includes a substrate 50, a c-axis-oriented ferroelectric thin film (ABX₃-type ferroelectric thin film) 60, an intermediate dielectric thin film (third dielectric thin film) 95, dielectric thin films (first dielectric thin films) 91 and 92, and a cladding (second dielectric thin film) 85. In this case, of the Mach-Zehnder optical waveguide 20, at least the first optical waveguide 23 and the second optical waveguide 24 include the ferroelectric thin film 60, the intermediate dielectric thin film 95, the dielectric thin films 91 and 92, and the cladding 85.

The ferroelectric thin film 60 in the optical modulation element 11B has the same configuration as the c-axis-oriented ferroelectric thin film 60 of the optical modulation element 11A, and has a flat plate shape not including a ridge portion 62 protruding from the upper surface 60a thereof (see FIG. 3A).

The intermediate dielectric thin film 95 is formed on the ferroelectric thin film 60. The dielectric thin films 91 and 92 are formed on the intermediate dielectric thin film 95. That is, in the optical modulation element 11B, the intermediate dielectric thin film 95 is interposed between the ferroelectric thin film 60 and the dielectric thin films 91 and 92, and the dielectric thin films 91 and 92 are formed on the ferroelectric thin film 60 via the intermediate dielectric thin film 95.

The cladding 85 is formed on the intermediate dielectric thin film 95 and the dielectric thin films 91 and 92. In the dielectric thin films 91 and 92, the lower surfaces 91-4 and 92-4 are covered with the intermediate dielectric thin film 95, and the upper surfaces 91-1 and 92-1 and the side surfaces 91-2, 91-3, 92-2, and 92-3 are covered with the cladding 85. That is, the intermediate dielectric thin film 95, the dielectric thin films 91 and 92, and the cladding 85 constitute a buried structure in which the dielectric thin films 91 and 92 are embedded in the intermediate dielectric thin film 95 and the cladding 85.

The intermediate dielectric thin film 95 and the cladding 85 function as cladding layers that confine light in the dielectric thin films 91 and 92 and the ferroelectric thin film 60. Therefore, the refractive indexes of the intermediate dielectric thin film 95 and the cladding 85 are lower than the refractive indexes of the ferroelectric thin film 60 and the dielectric thin films 91 and 92.

The intermediate dielectric thin film 95 includes a material having transparency (transmissivity to propagating light). As the intermediate dielectric thin film 95, for example, aluminum oxide (Al₂O₃), silicon dioxide (SiO₂), LaAlO₃, LaYO₃, ZnO, HfO₂, MgO, Y₂O₃, or the like can be used. The intermediate dielectric thin film 95 and the cladding 85 may be made of the same material or different materials.

The dielectric thin films 91 and 92 and the ferroelectric thin film 60 are optically coupled via the intermediate dielectric thin film 95. The dielectric thin films 91 and 92, the intermediate dielectric thin film 95, and the ferroelectric thin film 60 are optically coupled and function as a three-dimensional optical waveguide, thereby forming a hybrid-type optical waveguide. Since the dielectric thin films 91 and 92 have a refractive index higher than that of the intermediate dielectric thin film 95, they suppress light in the ferroelectric thin film 60 from spreading greatly in the horizontal direction.

The optical modulation element 11B can be produced without using a bonding technique by laminating the ferroelectric thin film 60, the intermediate dielectric thin film 95, the dielectric thin films 91 and 92, the cladding 85, and the electrodes 31 and 32 in this order on the substrate 50. The optical modulation element 11B thus produced has a low-defect film structure with precisely controlled film thicknesses.

In the optical modulation elements 11A and 11B of the present embodiment, an excellent electro-optic effect can be exhibited by using a lithium niobate thin film or a lithium tantalate thin film as the ferroelectric thin film 60. Since the ferroelectric thin film 60 is a sputtered thin film, the optical modulation elements 11A and 11B are excellent in mass productivity and cost reduction. In the present embodiment, a waveguide can be configured without processing the ferroelectric thin film 60, and it is possible to suppress a decrease in propagation loss caused by sidewall roughness or the like resulting from waveguide processing.

The optical modulation elements 11A and 11B of the present embodiment are not limited to the schematic cross-sectional configurations shown in FIGS. 3B and 3C. For example, other dielectric thin films (not shown) may be provided on the side surface sides 91-2, 91-3, 92-2, and 92-3 of the dielectric thin films 91 and 92. The function as a cladding layer of the cladding 85 may be further enhanced. The other dielectric thin films may be formed of, for example, silicon dioxide or aluminum oxide, which has a large refractive index difference from the ferroelectric thin film 60 serving as an electro-optic material and is excellent in the effect of confining light in the ferroelectric thin film 60.

Hereinafter, a method for manufacturing the optical modulation element 11A of FIG. 3B will be described with reference to FIG. 3D. FIG. 3D is a diagram schematically illustrating a method for manufacturing the optical modulation element 11A of FIG. 3B.

As shown in FIG. 3D, in manufacturing the optical modulation element 11A, a sapphire single-crystal substrate is prepared as the substrate 50, and a ferroelectric thin film 60 such as a lithium niobate film is formed over the entire main surface of the substrate 50 by a sputtering method. The upper surface of the ferroelectric thin film 60 is then planarized by chemical mechanical polishing (CMP) (step S1).

Next, a dielectric thin film 90 having a thickness of, for example, 100 to 1000 nm and including, for example, Si₃N₄ is formed on the upper surface of the ferroelectric thin film 60 by a CVD method (step S2).

Next, a photoresist is spin-coated on the upper surface of the dielectric thin film 90 and cured. Further, the photoresist is exposed and developed using a photomask, thereby forming resist patterns 94 corresponding to the dielectric thin films 91 and 92 (step S3).

Next, the dielectric thin film 90 is etched using the resist patterns 94 as a mask, thereby forming the dielectric thin films 91 and 92. As the etching method, RIE (Reactive Ion Etching) or ion milling can be used. The resist patterns 94 are then removed (step S4).

Next, a cladding 85 made of SiO₂, Al₂O₃, or the like is formed on the ferroelectric thin film 60 and the dielectric thin films 91 and 92 by a CVD method. The upper surface of the cladding 85 is then planarized by CMP (step S5).

Thereafter, electrodes 31 and 32 respectively covering the upper sides of the dielectric thin films 91 and 92 are formed in order on the upper surface of the cladding 85 (step S6). In this manner, the optical modulation element 11A of FIG. 3B can be manufactured.

In manufacturing the optical modulation element 11B shown in FIG. 3C, after the ferroelectric thin film 60 is formed on the substrate 50, the intermediate dielectric thin film 95 is formed on the upper surface of the ferroelectric thin film 60, and the dielectric thin film 90 is formed on the intermediate dielectric thin film 95. Thus, the optical modulation element 11B of FIG. 3C can be manufactured with the intermediate dielectric thin film 95 interposed between the ferroelectric thin film 60 and the dielectric thin films 91 and 92.

An example of a laser beam scanning method using the optical modulator 101 in this embodiment will be described.

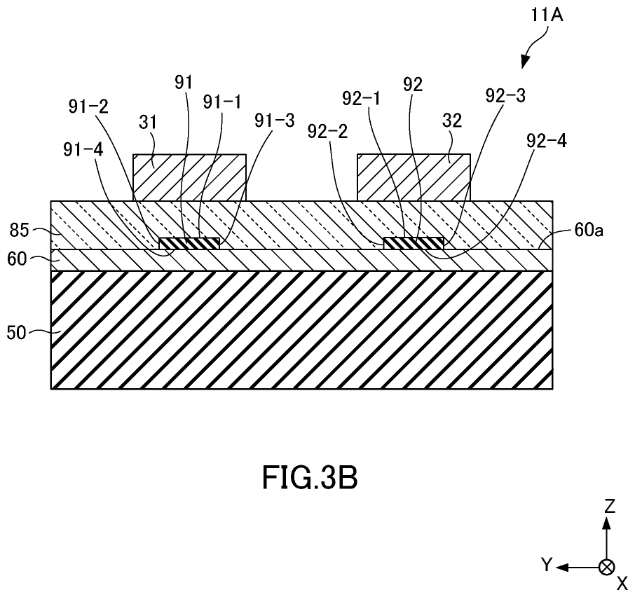

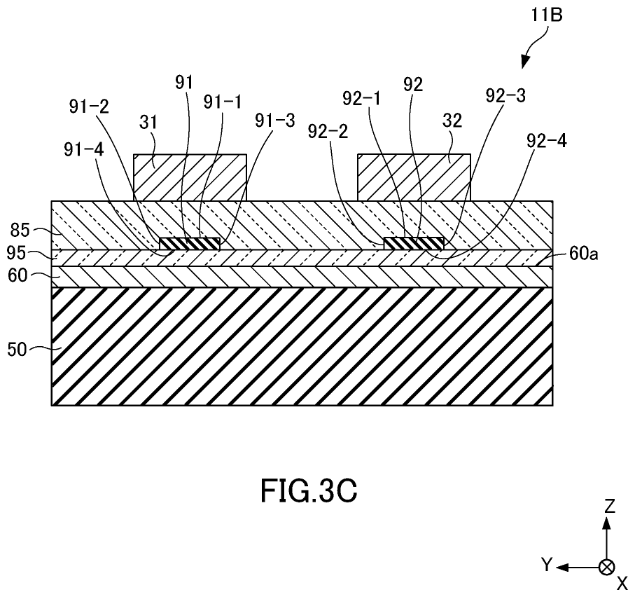

FIG. 4 shows a drawing area on an image display surface, and is a conceptual diagram showing an example of a scanning method when an image is displayed by changing the intensity (color tone) of output light for each pixel while scanning a laser beam using an image display device equipped with the optical modulator 101 in this embodiment. FIG. 5 is a conceptual diagram showing time on the horizontal axis and a pattern of pixel voltages (pixel signals) applied to one of the multiple Mach-Zehnder optical waveguides 20A, 20B, and 20C on the vertical axis.

As shown in FIG. 4, a laser beam is scanned in sequence to form an image. The start time of scanning for displaying one image is to, and the end time of scanning is t₁.

The arrow in FIG. 4 indicates the scanning direction of the laser beam, which is scanned horizontally from left to right, one pixel at a time. When it reaches the right end, it moves down one row vertically and scans one pixel horizontally from right to left, and when it reaches the left end, it moves down one row vertically and scans one pixel horizontally from left to right. By repeating such scanning, the entire image is displayed. Here, the scanning method of raster scanning is explained as an example, but scanning methods such as vector scanning and Lissajous scanning, which scan one pixel at a time, may also be used.

As the laser beam moves through each dot (pixel) of the image, the color of the laser changes according to time. It takes a certain amount of time to form one image, but since it is too fast for the human eye to follow, it is recognized as one image. The scanning speed of the laser beam is generally about 100 to 500 MHz (a speed at which the entire image is switched 60 times per second).

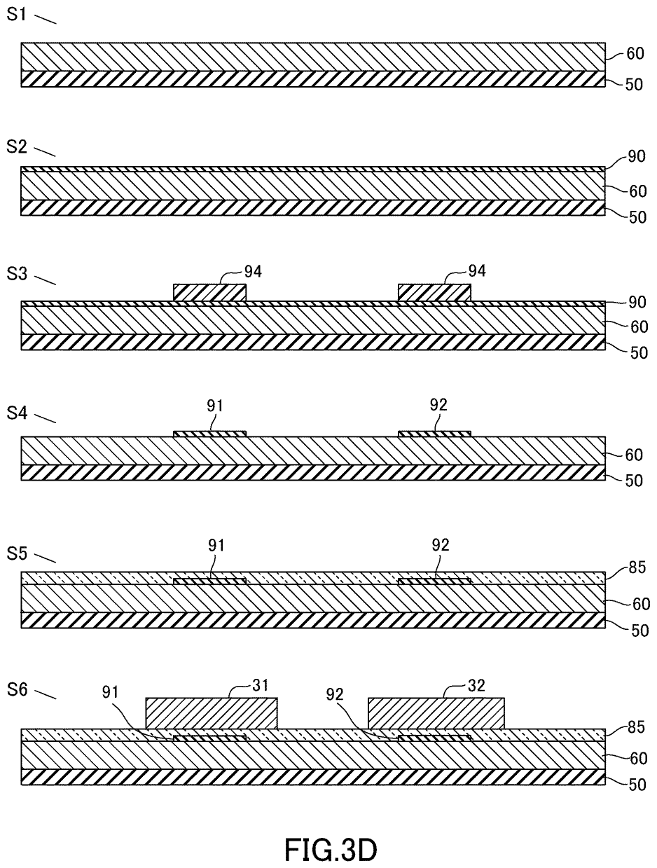

FIG. 6 is a conceptual diagram showing the arrangement of three consecutive pixels that make up an image. The color displayed at each pixel is determined by the combination of the intensity of the output light of the three colors red (R), green (G), and blue (B).

The color tone can be changed by changing the intensity of the output light of the three primary colors of light, red (R), green (G), and blue (B). For example, if the output light intensity of each color is changed with 8 bits of red, 8 bits of green, and 8 bits of blue, a combination of these can represent 24 bits of color tone (approximately 16.77 million colors) (24-bit color system). In the 24-bit color system, each RGB color has 8 bits of information, and each can be reproduced in 256 gradations. For each of the RGB, there are voltage values ranging from 0 to 255. For example, when all of the RGB are 0, the result is black, and when all are 255, the result is white. In other words, the intensity of the output light of each color is adjusted by controlling the voltage value applied to the Mach-Zehnder optical waveguides 20A, 20B, and 20C corresponding to each of the RGB colors. This allows the desired color tone to be reproduced in each pixel of the image display device.

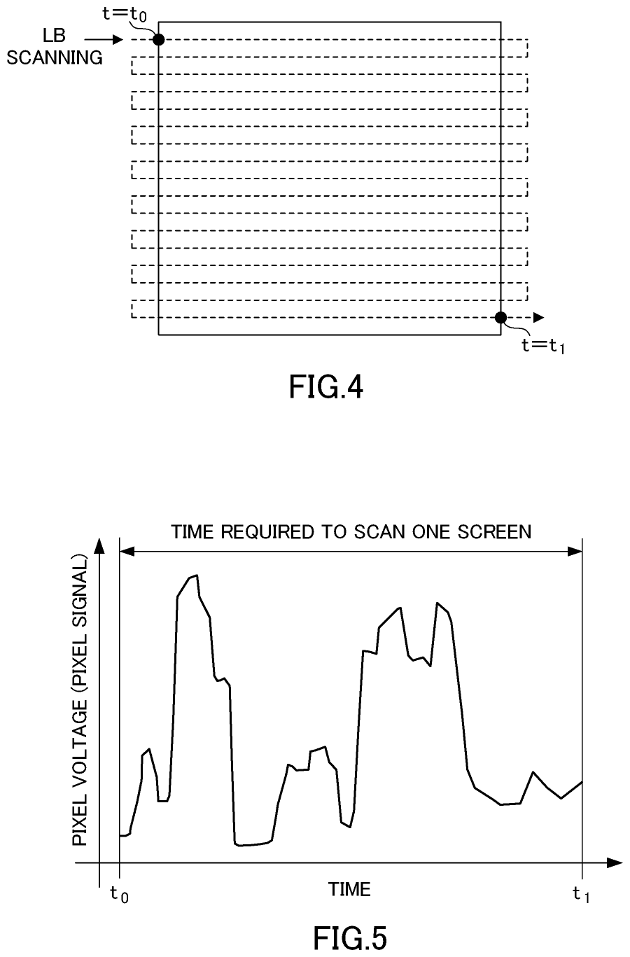

FIG. 7 is a conceptual diagram illustrating the combination of pixel voltages (pixel signals) of each of the RGB colors for each of 1280 pixels in one row when the number of pixels in one image is “1280×720”. In FIG. 7, pixel numbers 1 to 1280 are assigned to the 1280 pixels that make up one row in the horizontal direction of the image. In raster scanning, the intensity of the output light of three colors, red (R), green (G), and blue (B), is appropriately set while scanning each pixel (pixel number 1 to 1280) arranged horizontally, and then the scanning is repeated with each pixel shifted vertically to display the entire image. If the drawing time for one pixel is 10 ns (nanoseconds), the time required to scan one row is 12.8 μs (microseconds), and the time required to display one screen is approximately 10 ms (milliseconds).

The voltage control related to the optical modulator 101 will be described. FIG. 8 is a block diagram for explaining the control function of the optical modulator 101 in the first embodiment of the present disclosure. The optical modulator 101 has an optical modulation element 11 and a control portion 110 electrically connected to the optical modulation element 11. Note that, as described above, the optical modulation element 11 can be replaced with the optical modulation element 11A according to the first modified example or the optical modulation element 11B according to the second modified example.

The control portion 110 has a function of controlling the voltage applied to the Mach-Zehnder optical waveguide 20 of the optical modulation element 11. The control portion 110 may be configured as control circuitry. As shown in FIG. 8, the control portion 110 has a voltage application portion 111, a drive circuit 112, an offset voltage application circuit 113, a feedback control circuit 114, and a table storage portion 115. The voltage application portion 111 may be configured as voltage application circuitry. The table storge portion 115 may be configured as a table storage memory.

The voltage application portion 111 has a drive circuit 112 and an offset voltage application circuit 113. A modulation signal generation circuit (not shown) that generates a modulation signal Sm is connected to the voltage application portion 111. The modulation signal Sm is an electrical signal indicating the luminance (brightness) of each pixel, and constitutes the input pixel signal of the present disclosure.

When the modulation signal Sm is input, the voltage application portion 111 specifies a voltage value corresponding to the modulation signal Sm, and controls the drive circuit 112 and the offset voltage application circuit 113 to output a voltage of the specified voltage value. In this embodiment, the voltage application portion 111 refers to a table 116 stored in the table storage portion 115 to specify a voltage value corresponding to the modulation signal Sm, and controls the voltage output from the drive circuit 112 and the offset voltage application circuit 113 based on the specified voltage value. When a voltage is applied from the drive circuit 112 and the offset voltage application circuit 113 to the electrodes 31 and 32, an electric field corresponding to the voltage value is generated between the electrodes 31 and 32, and the light traveling through the Mach-Zehnder optical waveguide 20 is modulated. As a result, light with an intensity according to the voltage value corresponding to the input modulation signal Sm is output from the optical modulator 101.

The drive circuit 112 is a circuit that applies the modulation voltage Vm to the electrodes 31 and 32. The drive circuit 112 includes a first power source 41 (see FIG. 1) that generates the modulation voltage Vm.

The offset voltage application circuit 113 is a circuit that applies the offset voltage Voff to the electrodes 31 and 32. The offset voltage application circuit 113 includes a second power source 42 (see FIG. 1) that generates the offset voltage Voff. The offset voltage application circuit 113 adjusts the output offset voltage Voff by feedback control of the feedback control circuit 114.

The feedback control circuit 114 is a circuit that monitors the output light Lout and feedback controls the offset voltage application circuit 113 based on the monitoring result. This controls the voltage value of the offset voltage Voff, and for example, the bias point can be adjusted. The feedback control circuit 114 does not necessarily have to be provided.

The table storage portion 115 is a storage portion that stores the table 116 so that it can be referenced by the voltage application portion 111. The table 116 is a look-up table that stores voltage values corresponding to the modulation signal Sm (input pixel signal). The voltage application portion 111 refers to the table 116 to specify the voltage value corresponding to the input modulation signal Sm.

The modulation characteristics of the optical modulator 101 will be described below. The table 116 stores voltage values based on the modulation characteristics that reflect gamma correction as voltage values corresponding to the modulation signal Sm.

Gamma correction is a conversion of gradation values according to human visual characteristics. Each color of RGB is reproduced in, for example, 256 gradations. Gradation is basically linear, but according to human visual characteristics, for example, colors with intermediate luminance tend to be perceived as darker than their actual brightness. For this reason, the brightness of each pixel is converted, for example, into a gradation value that is suitable for human vision by gamma correction.

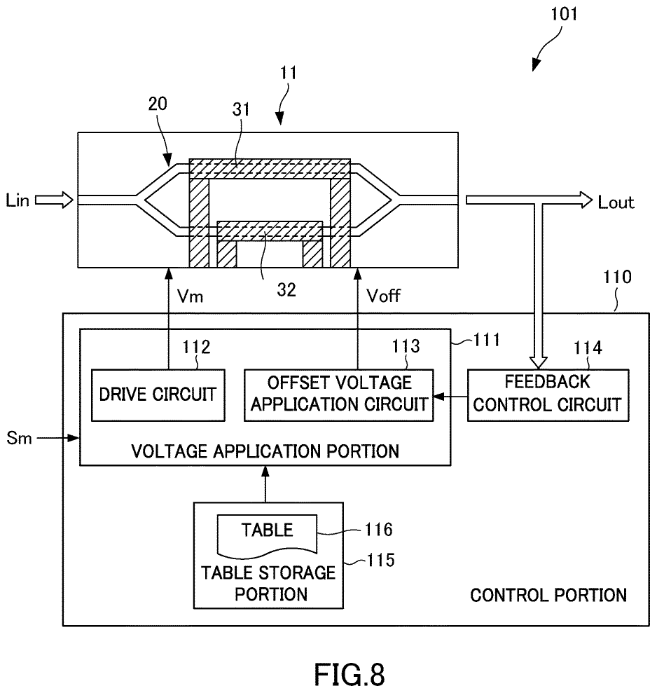

FIG. 9 is a graph showing an example of a tone curve in gamma correction. The horizontal axis represents the gradation value before gamma correction, and the vertical axis represents the gradation value after gamma correction. In gamma correction, the gamma value is used to convert the gradation value with a function of (1/gamma value). Gamma correction is generally expressed by the following equation (1).

$$\begin{matrix}[ Equation 1 ] & \\ {I}_{dst} = 255 \times {( \frac{{I}_{src}}{255} )}^{1 / γ} & ( 1 )\end{matrix}$$

Here, I_{src} is the gradation value before gamma correction, I_{dst} is the gradation value after gamma correction, and γ is the gamma value.

In gamma correction, the gamma value is appropriately determined according to the display characteristics of the image display device, and the gradation value is converted to be suitable for human vision. By converting linear gradation values to values that follow a nonlinear curve, it is possible to make the gradation values suitable for human vision. When the gamma value is 1 (γ=1), the gradation values do not change before and after gamma correction, and essentially no gamma correction is performed, so the linearity of the gradation values is maintained.

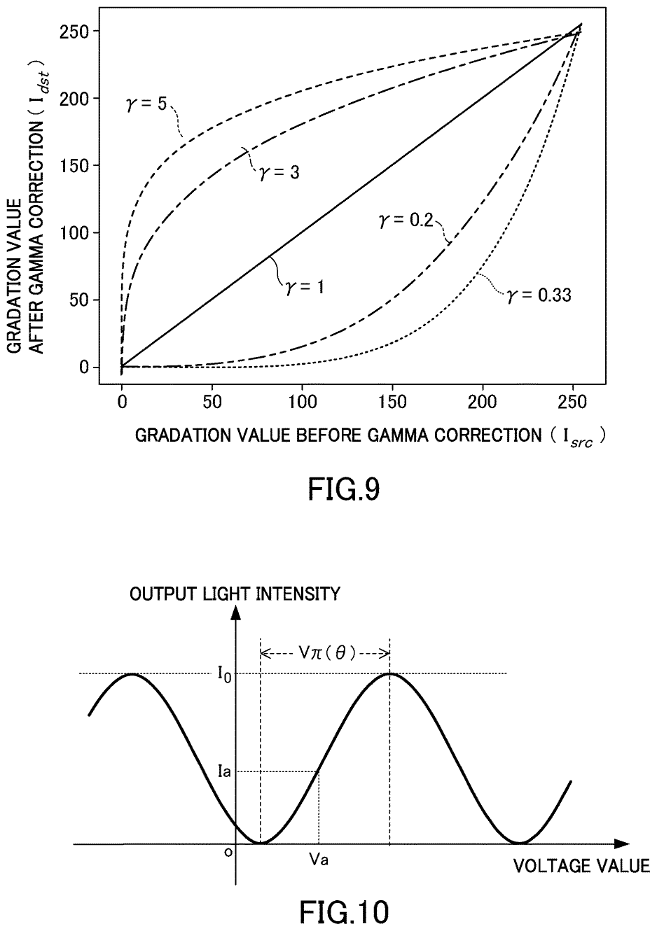

FIG. 10 is a graph showing an example of a typical modulation curve of the Mach-Zehnder optical waveguide 20. The horizontal axis represents the voltage value (the voltage value applied to the electrodes 31 and 32), and the vertical axis represents the output light intensity.

The modulation curve in the Mach-Zehnder optical waveguide 20 is basically expressed by the following equation (2).

$$\begin{matrix}[ Equation 2 ] & \\ {I}_{out} ( V , θ ) = {I}_{0} \cdot {cos}^{2} ( \frac{πV}{2 {V}_{π} ( θ )} + \frac{{ϕ}_{0}}{2} ) & ( 2 )\end{matrix}$$

Here, Iₒᵤₜ is the output light intensity, I₀ is the maximum value of the output light intensity, V is the voltage value (applied voltage) applied to the electrodes 31 and 32, θ is the angle (polarization angle) between the polarization direction of the input light and the optical axis of the ferroelectric thin film 60, V_{π}(θ) is the half-wave voltage at the polarization angle θ, and φ₀ is the initial phase difference.

The output light intensity Iₒᵤₜ is expressed by a function of the square of a cosine function with respect to the voltage value. As shown in FIG. 10, the modulation curve is a nonlinear curve with periodicity. For example, when a voltage value Va is applied, light with intensity Ia is output. Furthermore, when an offset voltage (e.g., a bias voltage) is added, the entire modulation curve shifts in the horizontal direction by the amount of the offset voltage.

The output light intensity is dependent on the polarization angle. The output light intensity is expressed by the above equation (2).

The effective electro-optic coefficient is expressed by the following equation (3).

[Equation 3]

r_{eff}(θ)=r₁₃ cos² θ+r₃₃ sin² θ (3)

Here, r₁₃ and r₃₃ are electro-optic coefficients corresponding to the width and height directions of the optical modulation element 11, respectively. Using this effective electro-optic coefficient, the half-wave voltage V_{π}(θ) can be written as the following equation (4).

$$\begin{matrix}[ Equation 4 ] & \\ {V}_{π} ( θ ) = \frac{K}{{r}_{eff} ( θ )} = \frac{K}{{r}_{13} {cos}^{2} θ + {r}_{33} {sin}^{2} θ} & ( 4 )\end{matrix}$$

This proportionality constant K is expressed by the following equation (5).

$$\begin{matrix}[ Equation 5 ] & \\ K = \frac{λ d}{{n}^{3} L} & ( 5 )\end{matrix}$$

Here, λ is the wavelength, d is the distance between the electrodes, n is the refractive index, and L is the electrode length.

The effective electro-optic coefficient can be rewritten as the following equation (6).

$$\begin{matrix}[ Equation 6 ] & \\ {r}_{eff} ( θ ) = \frac{1}{2} ( {r}_{13} + {r}_{33} ) + \frac{1}{2} ( {r}_{13} - {r}_{33} ) cos 2 θ & ( 6 )\end{matrix}$$

The modulation curve representing the output light intensity can be written as the following equation (7).

$$\begin{matrix}[ Equation 7 ] & \\ {I}_{out} ( V , θ ) = {I}_{0} \cdot {cos}^{2} ( \frac{πV}{2 K} {r}_{eff} ( θ ) + \frac{{ϕ}_{0}}{2} ) & ( 7 )\end{matrix}$$

From the equation (6), the effective electro-optic coefficient is a function of twice the polarization angle. From this, it can be seen that in the equation (7), the output light intensity changes as a function of twice the polarization angle. In order to control the light modulation more accurately, it is important to take this polarization dependency into consideration. Note that the above equations (1) to (7) are applicable not only to the ridge-type optical waveguide according to the present embodiment but also to the hybrid-type optical waveguide described later. However, the specific numerical values of the respective coefficients included in the equations may differ depending on the material and structure.

According to the prior art, the methods of gamma correction include a method of performing image processing before light modulation and a method of performing gamma correction on the output light. In contrast, in this embodiment, two processes that were previously performed independently, namely gamma correction based on human visual characteristics and correction (calibration) in the light modulation of the Mach-Zehnder optical waveguide 20, are integrated. In particular, by utilizing the nonlinearity of the modulation characteristics in the optical modulation of the Mach-Zehnder optical waveguide 20 and reflecting gamma correction in this modulation characteristic, it is possible to improve the efficiency of processing.

In gamma correction, a conversion is performed using a function of (1/gamma value), while in optical modulation of the Mach-Zehnder optical waveguide 20, a conversion is performed using a function of a squared cosine function. In view of this, in this embodiment, the output optical intensity of the optical modulator 101 is expressed as a function of a cosine function of (2/gamma value), thereby reflecting gamma correction in the modulation characteristics in the optical modulation of the Mach-Zehnder optical waveguide 20. Specifically, the output optical intensity Iₒᵤₜ is determined by the following equation (8):

$$\begin{matrix}[ Equation 8 ] & \\ {I}_{out} = {I}_{γ} ( V , θ ) = {I}_{0} \cdot {cos}^{2 / γ} ( \frac{π}{2 {V}_{π} ( θ )} \cdot [ V + {V}_{offset} ] ) & ( 8 )\end{matrix}$$

Here, I₀ is the maximum value of the output light intensity, V is the voltage value of the modulation voltage Vm, V_{offset} is the voltage value of the offset voltage Voff, θ is the angle (polarization angle) between the polarization direction of the input light and the optical axis of the ferroelectric thin film 60, V_{π}(θ) is the half-wave voltage at the polarization angle θ, and γ is the gamma value. In this embodiment, the optical modulator 101 applies the modulation voltage Vm from the drive circuit 112 and the offset voltage Voff from the offset voltage application circuit 113, and the sum of these voltages is applied to the electrodes 31 and 32. According to the above equation (8), it is possible to obtain a modulation curve that reflects the gamma correction and polarization dependency.

The output light intensity is dependent on the gamma value. In the above equation (8), the gamma value can be flexibly changed and can be set appropriately according to, for example, the characteristics of the image display device. The gamma value may be smaller than 1 and the exponent of the cosine function may be larger than 2, or the gamma value may be larger than 1 and the exponent of the cosine function may be smaller than 2. The gamma value may be 1 and the exponent of the cosine function may be 2, which is the exponent of a general modulation curve. The gamma value may be 2.2, which is a standard value.

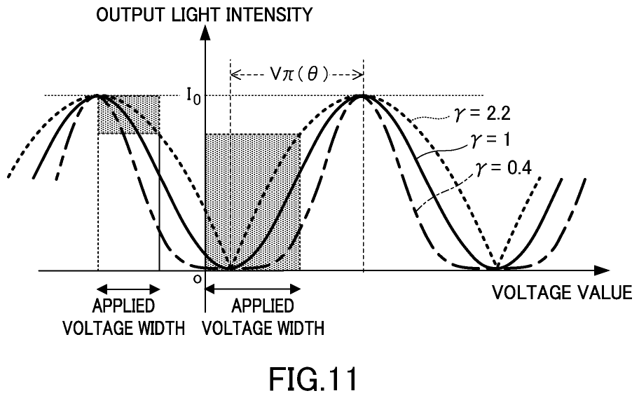

FIG. 11 is a graph showing a modulation curve reflecting gamma correction in the first embodiment of the present disclosure. The horizontal axis represents the voltage value (the voltage value applied to the electrodes 31 and 32), and the vertical axis represents the output light intensity. FIG. 11 shows graphs for γ=0.4, γ=1, and γ=2.2 as an example to show the difference in the curve shape from a general modulation curve (γ=1). Furthermore, the output light intensity is a physical quantity and usually takes a non-negative real value. The graph shown in FIG. 11 depicts a non-negative real solution to the above equation (8).

As shown in FIG. 11, when the gamma value is greater than 1 (γ=2.2), the change becomes gentler in the region where the output light intensity is high, compared to when the gamma value is 1 (γ=1), and when the gamma value is less than 1 (γ=0.4), the change becomes gentler in the region where the output light intensity is low.

The range of voltage values to be used (applied voltage width) and the range of output light intensity (light intensity range) can be set appropriately. For example, the voltage values at each position where 256 levels of linear output light intensity are obtained can be extracted and used. The range of voltage values to be used does not need to be a continuous range, and multiple separated ranges can be used. A low voltage range can also be used in consideration of power saving. FIG. 11 shows an example of the applied voltage width to be used when γ=2.2.

The output light intensity also depends on the polarization angle. As described above, the modulation curve and the output light intensity change as a function of the double angle of the polarization angle. The value of the polarization angle in the above equation (8) can be flexibly changed, and can be set appropriately according to, for example, the polarization mode and positional deviation of the light sources 211, 212, and 213, the orientation of the ferroelectric thin film 60, and the like.

The voltage values corresponding to the modulation signal Sm (input pixel signal) stored in the table 116 will be explained.

The value of the modulation signal Sm and the voltage value corresponding to the modulation signal Sm are stored in association with each other in the table 116. The value of the modulation signal Sm is, for example, a discrete value of 256 gradations representing brightness, and a voltage value is set for each value of the modulation signal Sm.

The voltage values stored in the table 116 are set based on the modulation characteristics reflecting the gamma correction in order to obtain the desired output light intensity corresponding to the modulation signal Sm. In other words, the table 116 stores voltage values that comprehensively compensate for gamma correction that matches the human visual characteristics and the nonlinear modulation characteristics in the optical modulation of the Mach-Zehnder optical waveguide 20. The same gamma correction (same gamma value) may be applied to each color of RGB visible light, or different gamma corrections (different gamma values) may be applied.

The voltage values stored in the table 116 are determined by an equation including a function of a cosine function multiplied by (2/gamma value), specifically, the above equation (8).

The voltage value corresponding to the output light intensity is calculated using a correction function that has the inverse characteristic of the modulation characteristic. This correction function is, for example, the inverse function of the above equation (8), and is expressed by an arccosine function with the output light intensity raised to the power of (γ/2) as an argument. Specifically, the inverse function of the above equation (8) is expressed by the following equation (9). The correction function has calculation parameters such as gamma value and polarization angle, as in the modulation curve equation included in the above equation (8).

$$\begin{matrix}[ Equation 9 ] & \\ V + {V}_{offset} = \frac{2 {V}_{π} ( θ )}{π} \cdot arccos ( {( \frac{{I}_{out}}{{I}_{0}} )}^{γ / 2} ) & ( 9 )\end{matrix}$$

When a target output light intensity is input to the correction function expressed by the above equation (9), a voltage value that will obtain this output light intensity can be calculated. The voltage value calculated using the correction function realizes the corresponding output light intensity, and is associated with each value of the modulation signal Sm that indicates the brightness of the pixel. The value of the modulation signal Sm and the output light intensity have linearity. If the value of the modulation signal Sm is, for example, a discrete value of 256 gradations, a voltage value for realizing the discrete value of 256 gradations for the output light intensity may be calculated. The calculated voltage value is stored in the table 116 in a state associated with the modulation signal Sm.

The voltage application portion 111 refers to the table 116 to identify the voltage value that corresponds to the input modulation signal Sm. When the specified voltage value is applied to the electrodes 31 and 32, light with an intensity corresponding to the modulation signal Sm is output based on the voltage value. When the offset voltage Voff is a constant value, the voltage application portion 111 only needs to control the modulation voltage Vm.

According to the first embodiment, by incorporating gamma correction into the modulation characteristics of the Mach-Zehnder optical waveguide 20, the optical modulator 101 can specify a voltage value that reflects gamma correction for the modulation signal Sm (input pixel signal). As a result, an optical output that reflects gamma correction can be realized, and the visibility and reproducibility of images in visual display can be improved.

### Second Embodiment

The second embodiment of the present disclosure will be described below. Furthermore, the same components as those in the first embodiment described above are denoted by the same reference numerals and will not be described hereinafter as appropriate.

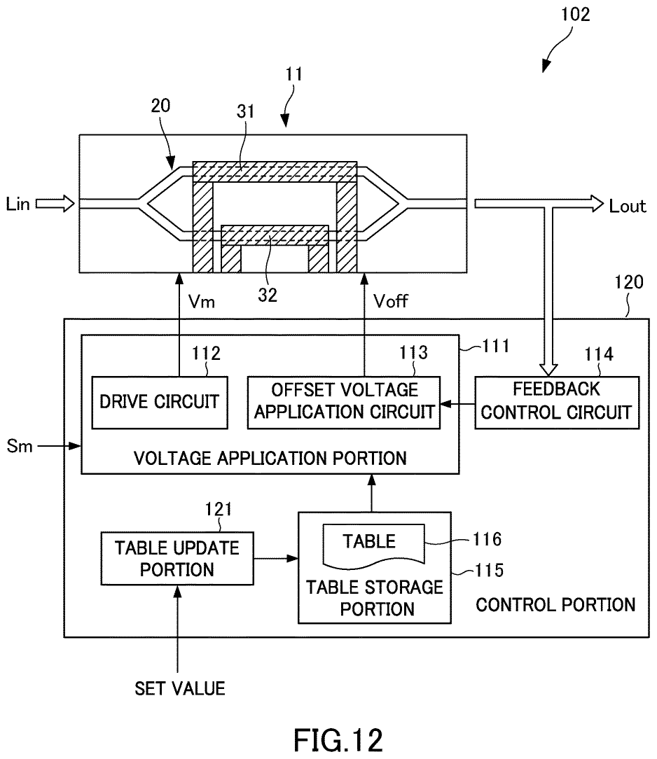

FIG. 12 is a block diagram for explaining the control function of the optical modulator 102 in the second embodiment of the present disclosure. The optical modulator 102 differs from the optical modulator 101 in the first embodiment at least in that the control portion 120 has a table update portion 121. The table update portion 121 may be configured as table update circuitry.

The table update portion 121 is configured to update the table 116 based on an external input. The table update portion 121 accepts a set value input from the outside. Examples of the external input include an input by an operator, reading of a set value stored in a storage medium, and output of a calculation result of a correction function by a calculation device. The set value includes a voltage value corresponding to the modulation signal Sm. The table update portion 121 sets this set value in the table 116, thereby dynamically updating the table 116.

According to the second embodiment, the table update portion 121 can dynamically update the table 116, thereby improving the flexibility and customizability in the control of the optical modulator 102. For example, even after the voltage value corresponding to the modulation signal Sm is set in the table 116, it is possible to change to a new set value by adjusting the gamma value, polarization angle, etc. according to the usage environment and device characteristics. This makes it possible to flexibly respond to error correction and changes to desired image display characteristics.

### Third Embodiment

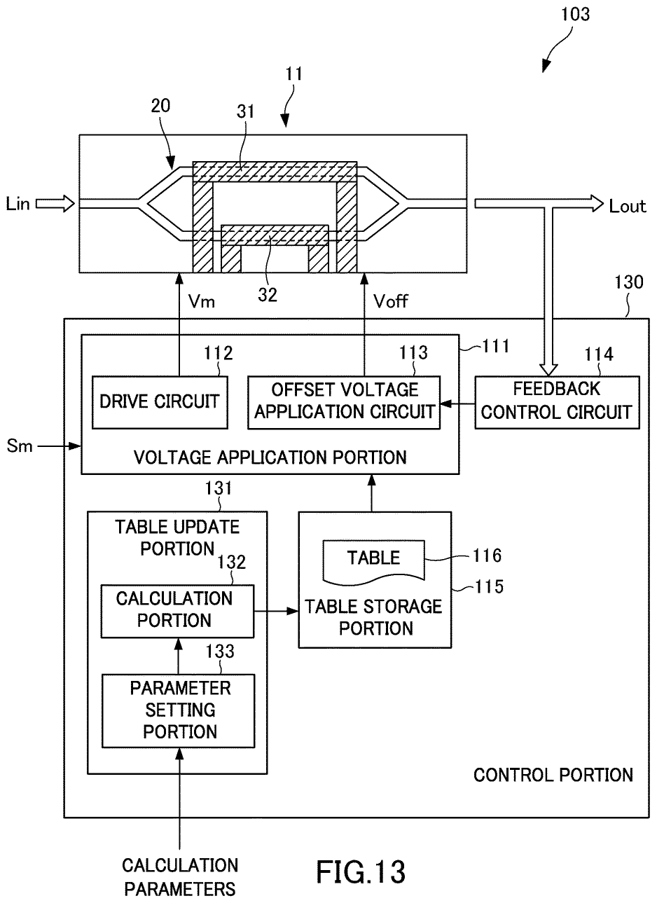

The third embodiment of the present disclosure will be described below. Furthermore, the same components as those in the first embodiment described above are given the same reference numerals and their description will be omitted as appropriate. FIG. 13 is a block diagram for explaining the control function of the optical modulator 103 in the third embodiment of the present disclosure. The optical modulator 103 differs from the optical modulator 102 in the second embodiment at least in that the control portion 130 has a calculation portion 132 and a parameter setting portion 133. The calculation portion 132 may be configured as calculation circuitry. The parameter setting portion 133 may be configured as parameter setting circuitry.

The table update portion 131 is configured to update the table 116 based on an input from outside. The table update portion 131 includes a calculation portion 132 and a parameter setting portion 133.

The calculation portion 132 is configured to calculate a voltage value for the modulation signal Sm by calculation. The calculation portion 132 performs calculations using a correction function expressed by, for example, the above equation (9). The calculation parameters used in the correction function are set by the parameter setting portion 133. The calculation portion 132 applies the set calculation parameters to the correction function to calculate a voltage value for the output light intensity indicated by the modulation signal Sm. At this time, if the scales of the modulation signal Sm and the output light intensity are different, an appropriate scale conversion may be performed.

The parameter setting portion 133 is configured to set calculation parameters in the calculation portion 132. The parameter setting portion 133 accepts calculation parameters as input from the outside. The calculation parameters are parameters set in the correction function, and include specific numerical values such as gamma values and polarization angles. Examples of input from the outside include input by an operator, reading of a set value stored in a storage medium, and detection results by a sensor or the like.

When the parameter setting portion 133 receives a specific value of a calculation parameter input from the outside, it sets the calculation parameter in the correction function of the calculation portion 132. When a new calculation parameter is set, the calculation portion 132 performs a calculation using the correction function and sets the calculation result in the table 116.

According to the third embodiment, the table 116 can be dynamically updated based on the input of the calculation parameter, and the flexibility and customizability in the control of the optical modulator 103 can be improved. In particular, by simply inputting a gamma value, a polarization angle, etc. according to the usage environment and device characteristics, the calculation portion 132 implemented in the optical modulator 103 automatically calculates a voltage value for the modulation signal Sm, which is excellent in ease of setting and convenience.

### Fourth Embodiment

The fourth embodiment of the present disclosure will be described below. Furthermore, the same components as those in the first embodiment described above are given the same reference numerals and the description will be omitted as appropriate.

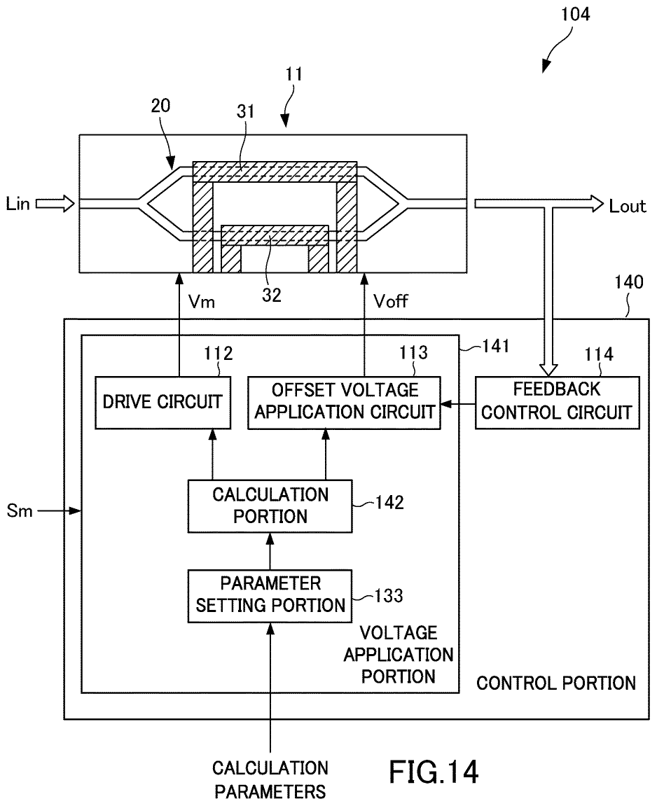

FIG. 14 is a block diagram for explaining the control function of the optical modulator 104 in the fourth embodiment of the present disclosure. The optical modulator 104 differs from the optical modulator 103 in the third embodiment at least in that the control portion 140 does not have a table storage portion 115.

The voltage application portion 141 has a drive circuit 112, an offset voltage application circuit 113, a calculation portion 142, and a parameter setting portion 133.

The calculation portion 142 is configured to calculate a voltage value for the modulation signal Sm by calculation, similar to the calculation portion 132 in the third embodiment described above. The calculation portion 142 performs calculations using a correction function expressed by, for example, the above equation (9). The calculation parameters used for the correction function are set by the parameter setting portion 133, as in the third embodiment described above. The calculation portion 142 applies the set calculation parameters to the correction function and calculates a voltage value corresponding to the output light intensity indicated by the modulation signal Sm. At this time, if the scales of the modulation signal Sm and the output light intensity are different, an appropriate scale conversion may be performed.

However, unlike the calculation portion 132 of the third embodiment described above, when the modulation signal Sm is input to the voltage application portion 141, the calculation portion 142 calculates a voltage value corresponding to the modulation signal Sm in real time by calculation. The drive circuit 112 and the offset voltage application circuit 113 are controlled to output the voltage value calculated by the calculation portion 142 in real time.

According to the fourth embodiment, the calculation portion 142 calculates a voltage value corresponding to the modulation signal Sm in real time, and the voltage output is controlled in real time based on the voltage value. This enables dynamic output control without using a table, and high responsiveness can be achieved in response to improvements in the computational processing power. In addition, the resources and effort required for managing the table can be reduced.

### (Optical Engine and XR Glasses)

The present disclosure can provide an optical engine equipped with a light source module 201 having the optical modulators 101, 102, 103, and 104 in the first to fourth embodiments described above. The optical engine is a device that includes the light source module 201, an optical scanning mirror that reflects the light emitted from the light source module 201 at a different angle to display an image, and a control element that controls the optical scanning mirror.

Furthermore, the present disclosure can provide an image display device equipped with the above optical engine. The image display device is a device that displays information that can be visually recognized as an image (still image and moving image) by projecting visible light of a color corresponding to each pixel onto a screen or directly onto the human retina. Examples of the image display device include XR glasses, projectors, and rear-projection type projection displays.

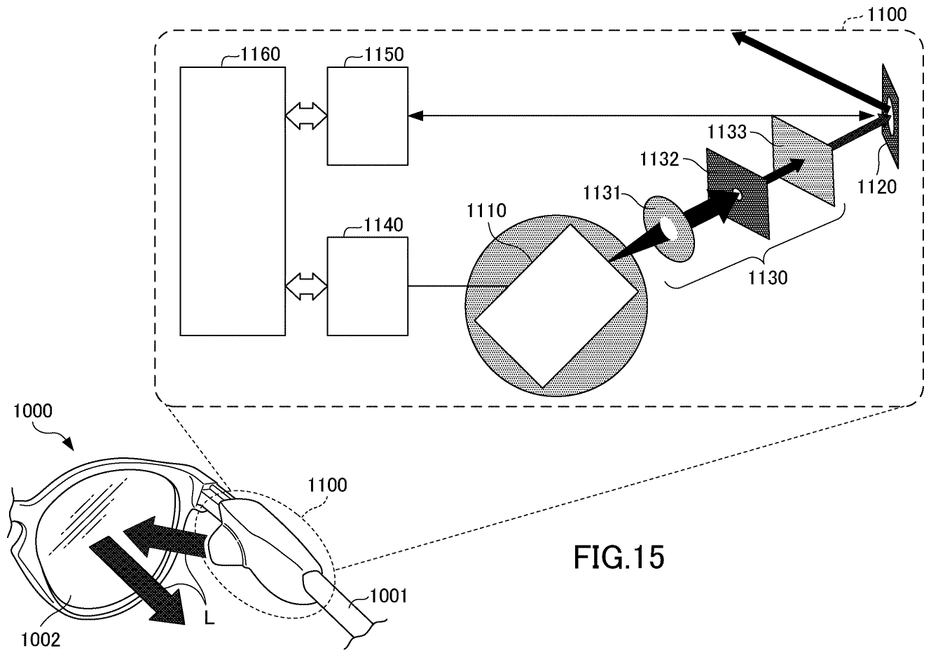

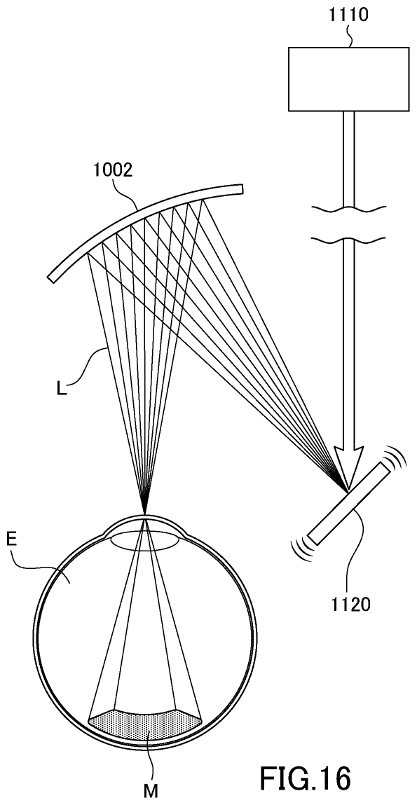

FIG. 15 is a conceptual diagram for explaining the XR glasses 1000, which is an example of the image display device according to the present disclosure. FIG. 16 is a conceptual diagram showing how an image is directly projected onto the retina M by the laser light R emitted from the light source module 1110 in the XR glasses 1000 shown in FIG. 15.

The XR glasses 1000 shown in FIG. 15 are glasses-type terminals, and an optical engine 1100 is installed in the frame 1001 of the glasses. The optical engine 1100 is equipped with a light source module 201 having the optical modulators 101, 102, 103, and 104 in the first to fourth embodiments described above as the light source module 1110.

As shown in FIG. 15, the optical engine 1100 includes a light source module 1110, an optical scanning mirror 1120, an optical system 1130 that connects the light source module 1110 and the optical scanning mirror 1120, a laser driver 1140, an optical scanning mirror driver 1150, and a video controller 1160 that controls these drivers.

For example, a MEMS mirror can be used as the optical scanning mirror 1120. To project a two-dimensional image, it is possible to use a two-axis MEMS mirror that vibrates to reflect laser light by changing the angle in the horizontal direction (X direction) and the vertical direction (Y direction) as the optical scanning mirror 1120.

The optical system 1130 optically processes the laser light emitted from the light source module 1110. The optical system 1130 may have, for example, a collimator lens 1131, a slit 1132, and an ND filter 1133. The optical system 1130 shown in FIG. 19 is an example, and other configurations may be used.

In the XR glasses 1000 shown in FIG. 15, as shown in FIG. 16, the laser light (image display light L) emitted from the light source module 1110 attached to the frame 1001 is reflected by the optical scanning mirror 1120 and further reflected by the lens 1002 of the XR glasses 1000. The reflected light (image display light L) reflected by the lens 1002 is incident on the human eyeball E and is focused on the retina M, allowing it to be visually recognized as an image.

The optical engine and image display device according to the present disclosure are provided with a light source module 201 having the optical modulators 101, 102, 103, and 104 in the first to fourth embodiments described above, and can perform optical output and image display that efficiently and appropriately reflects gamma correction.

Although the disclosure has been described with respect to only a limited number of embodiments, those skilled in the art, having benefit of this disclosure, will appreciate that various other embodiments may be devised without departing from the spirit and scope of the present disclosure. Accordingly, the technical scope of the disclosed subject matter should be limited only by the attached claims.

### DESCRIPTION OF REFERENCE NUMERALS AND SIGNS

11 Optical modulation element
20, 20A, 20B, 20C Mach-Zehnder optical waveguide (optical waveguide)
20Ai, 20Bi, 20Ci, 20i Input port
20Ao, 20Bo, 20Co, 200 Output port
21 Input optical waveguide
22 Splitter
23 First optical waveguide
24 Second optical waveguide
25 Multiplexer
26 Output optical waveguide
31, 32 Electrode
31a, 32a One end
31b, 32b Other end
41 First power source
42 Second power source
43 Termination resistor
50 Substrate
60 Ferroelectric thin film
61 Slab layer
62 Ridge portion
70 Protective layer
80 Buffer layer
85 Cladding
90, 91, 92 Dielectric thin film
95 Intermediate dielectric thin film
101, 102, 103, 104 Optical modulator
105 Light incidence surface
110, 120, 130, 140 Control portion
111, 141 Voltage application portion
112 Drive circuit
113 Offset voltage application circuit
114 Feedback control circuit
115 Table storage portion
121, 131 Table update portion
116 Table
132, 142 Calculation portion
133 Parameter setting portion
201 Light source module
210 Light source portion
211, 212, 213 Light source
214 Subcarrier
215 Light exit surface
1000 XR glass
1001 Frame
1002 Lens
1100 Optical engine
1110 Light source module
1120 Optical scanning mirror
1130 Optical system
1131 Collimator lens
1132 Slit
1133 ND filter
1140 Laser driver
1150 Optical scanning mirror driver
1160 Video controller

1. An optical modulator for modulating visible light, comprising:
an optical modulation element having a Mach-Zehnder optical waveguide formed therein and an electrode configured to apply an electric field to the Mach-Zehnder optical waveguide, and
voltage application circuitry for specifying a voltage value based on modulation characteristics reflecting gamma correction as a voltage value corresponding to an input pixel signal, and applying the specified voltage value to the electrode.

2. The optical modulator according to claim 1, wherein the output light intensity is expressed as a function of a cosine function raised to the power of (2/gamma value) based on the modulation characteristics reflecting gamma correction.

3. The optical modulator according to claim 2, wherein the output light intensity Iₒᵤₜ is determined by the following equation
$${I}_{out} = {I}_{γ} ( V , θ ) = {I}_{0} \cdot {cos}^{2 / γ} ( \frac{π}{2 {V}_{π} ( θ )} \cdot [ V + {V}_{offset} ] ) \qquad [ Equation 1 ]$$
based on the modulation characteristics reflecting gamma correction.
(Here, I₀ is the maximum value of the output light intensity, V is the voltage value of the modulation voltage, V_{offset} is the voltage value of the offset voltage, θ is the polarization angle of the input light, V_{π}(θ) is the half-wave voltage at the polarization angle θ, and γ is the gamma value.)

4. The optical modulator according to claim 1, wherein the optical modulator comprises a table storage memory that stores a table for storing the voltage values corresponding to the input pixel signal, and the voltage application circuitry refers to the table to identify the voltage value corresponding to the input pixel signal.

5. The optical modulator according to claim 4, wherein the optical modulator comprises table update circuitry that updates the table based on an external input.

6. The optical modulator according to claim 5, wherein the table update circuitry sets in the table the voltage value corresponding to the input pixel signal received as the external input.

7. The optical modulator according to claim 5, wherein the table update circuitry includes calculation circuitry that calculates the voltage value corresponding to the input pixel signal by calculation, and parameter setting circuitry that sets the calculation parameters received as the external input to the calculation circuitry, and the table update circuitry sets the voltage value corresponding to the input pixel signal calculated by the calculation circuitry in the table.

8. The optical modulator according to claim 1, wherein the voltage application circuitry includes calculation circuitry that calculates the voltage value corresponding to the input pixel signal by calculation, and parameter setting circuitry that sets the calculation parameters received as the external input to the calculation circuitry, and the voltage application circuitry specifies the voltage value corresponding to the input pixel signal by the calculation of the calculation circuitry.

9. The optical modulator according to claim 1, wherein the Mach-Zehnder optical waveguide comprises:
an input optical waveguide;
a splitter that branches the input optical waveguide;
a first optical waveguide and a second optical waveguide extending parallel to each other from the splitter;
a multiplexer that couples the first optical waveguide and the second optical waveguide; and
an output optical waveguide extending from the multiplexer.

10. The optical modulator according to claim 1, wherein
the optical modulation element comprises:
a substrate;
an ABX₃-type ferroelectric thin film formed on the substrate and having a ridge portion protruding from an upper surface thereof; and
a dielectric thin film covering the ridge portion and having a refractive index lower than that of the ABX₃-type ferroelectric thin film,
wherein a ridge-type optical waveguide is formed by the ridge portion.

11. The optical modulator according to claim 10, wherein the substrate is a single-crystal sapphire substrate, and the ABX₃-type ferroelectric thin film is a c-axis-oriented lithium niobate thin film.

12. The optical modulator according to claim 1, wherein
the optical modulation element comprises:
a substrate;
an ABX₃-type ferroelectric thin film formed on the substrate;
a first dielectric thin film formed on the ABX₃-type ferroelectric thin film and composed of a material different from that of the ABX₃-type ferroelectric thin film; and
a second dielectric thin film covering an upper surface and side surfaces of the first dielectric thin film and having a refractive index lower than those of the ABX₃-type ferroelectric thin film and the first dielectric thin film,
wherein a hybrid-type optical waveguide combining the ABX₃-type ferroelectric thin film and the first dielectric thin film is formed.

13. The optical modulator according to claim 12, wherein the lower surface of the first dielectric thin film is in contact with an upper surface of the ABX₃-type ferroelectric thin film.

14. The optical modulator according to claim 12, wherein an intermediate dielectric thin film is disposed between the ABX₃-type ferroelectric thin film and the first dielectric thin film, and an upper surface of the ABX₃-type ferroelectric thin film and a lower surface of the first dielectric thin film are in contact with the intermediate dielectric thin film.

15. The optical modulator according to claim 14, wherein the intermediate dielectric thin film contains a material having a refractive index lower than those of the ABX₃-type ferroelectric thin film and the first dielectric thin film and having transparency to propagating light.

16. The optical modulator according to claim 12, wherein the substrate is a single-crystal sapphire substrate, and the ABX₃-type ferroelectric thin film is a c-axis-oriented lithium niobate thin film.

17. The optical modulator according to claim 12, wherein the first dielectric thin film comprises silicon nitride.

18. The optical modulator according to claim 1, wherein a plurality of the Mach-Zehnder optical waveguides are formed in the optical modulation element.

19. A light source module comprising the optical modulator according to claim 10 and a plurality of light sources that each emit visible light of different wavelengths.

20. An image display device wherein an image is displayed using visible light output from the light source module according to claim 19.
